(19) United States
(12) Patent Application Publication
(10) Pub. No.: US 2016/0216953 A1
(43) Pub. Date: Jul. 28, 2016

(54) METHOD FOR SHOWING AN INSTANT NOTICE ON A DISPLAY OF COMPUTER ACCORDING TO AN INCOMING EVENT OF A MOBILE DEVICE

(71) Applicant: Cheng-Hui Pu, Taipei City (TW)

(72) Inventor: Cheng-Hui Pu, Taipei City (TW)

(73) Assignee: I/O INTERCONNECT INC., Taipei City (TW)

(21) Appl. No.: 14/857,941

(22) Filed: Sep. 18, 2015

Related U.S. Application Data
(63) Continuation-in-part of application No. 14/607,046, filed on Jan. 27, 2015.

(51) Int. Cl. G06F 9/445

(52) U.S. Cl. CPC G06F 8/61

(57) ABSTRACT

The invention provides a method for installing an application into a handheld computer and a personal computer, which are connected to each other. The method includes the steps of: a) connecting the handheld computer to the personal computer with a USB cable with a memory in which an ADK utility application is stored; b) installing the ADK utility application to the personal computer; c) directing the handheld computer to a specific website; d) downloading a specific program including a personal computer version and a handheld computer version; e) installing the handheld computer version of the specific program into the handheld computer; and f) installing the personal computer version of the specific program into the personal computer.

### CROSS-REFERENCE TO RELATED APPLICATIONS

This application is a continuation-in-part of U.S. patent application Ser. No. 14/607,046, filed Jan. 27, 2015, now pending.

### BACKGROUND OF THE INVENTION

1. Technical Field

This invention is related to the connection between a handheld computer and a personal computer, in particular to the installation of a software application (“application”) into both a handheld computer and a personal computer when they are connected together.

2. Related Art

Handheld computers, such as smartphones and tablets, have become essential for most people. These handheld computers are installed with many applications (also known as “apps”) that perform various functions. Some applications, which perform functions of cooperativity between a handheld computer and a personal computer such as a desktop or a laptop computer, need to be installed into both the handheld computer and the personal computer. A possible way is to use a special USB (universal serial bus) cable with an installing device equipped with a memory, and in which a complete software program, including a personal computer version and a handheld computer version, is stored. This cable is then used to connect a handheld computer and a personal computer.

Although the said software program can automatically install the handheld computer version and the personal computer version of the software program into the handheld computer and the personal computer, respectively, the capacity of the memory must be large enough to store the complete software program. This in turn will increase the manufacturing cost of the special USB cable.

### SUMMARY OF THE INVENTION

An objective of the invention is to provide a special method for installing an application into both a handheld computer and a personal computer, which can serve to substantially reduce the required capacity of the memory of the installing device attached on a USB cable which is used to install an application cooperating between a handheld computer and a personal computer.

To accomplish the said objective, the method of the invention includes the steps of: a) connecting the handheld computer to the personal computer with a USB (universal serial bus) cable equipped with a memory in which an ADK (Accessory Development Kit) utility application is stored; b) installing the ADK utility application to the personal computer; c) directing the handheld computer to a specific website; d) downloading a specific program from the website which includes a personal computer version and a handheld computer version; e) installing the handheld computer version of the specific program into the handheld computer; and f) installing the personal computer version of the specific program into the personal computer.

### BRIEF DESCRIPTION OF THE DRAWINGS

FIG. 1 is a schematic view of hardware arrangement of the invention; and

FIG. 2 is a flowchart of the method of the invention.

### DETAILED DESCRIPTION OF THE INVENTION

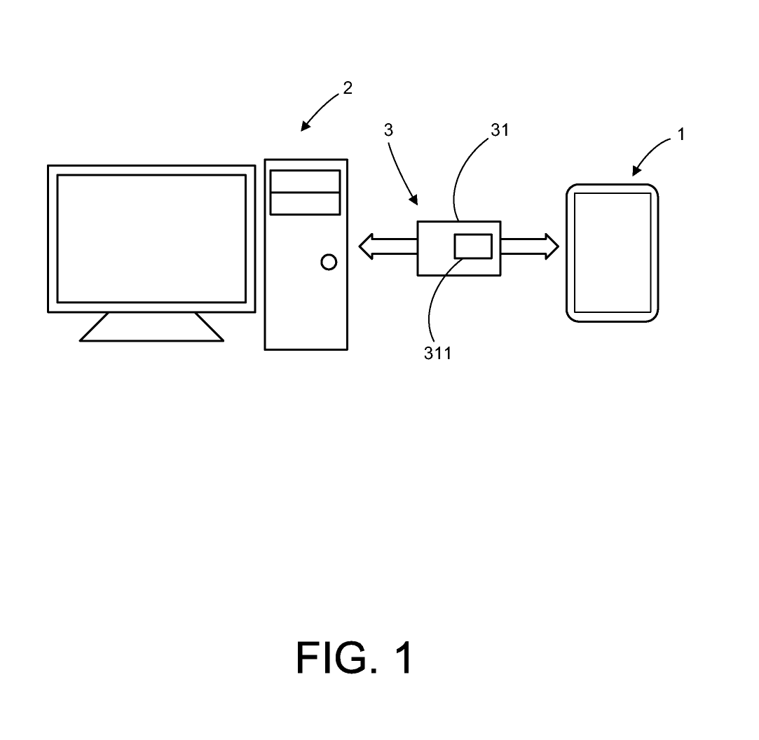

Please refer to FIG. 1. The invention provides a method for installing an application into a handheld computer 1 and a personal computer 2. The handheld computer 1 may be a smartphone or a tablet computer. The personal computer 2 may be a desktop or a laptop computer. A USB (universal serial bus) cable 3 is connected between the handheld computer 1 and the personal computer 2. The USB cable 3 is provided with an installing device 31 which contains a memory 311.

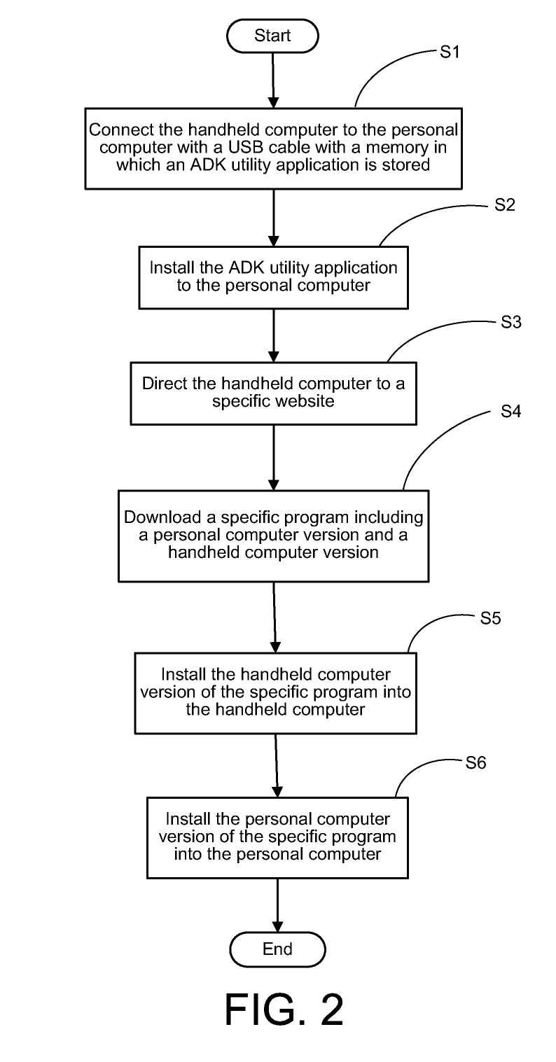

Please refer to FIG. 2, which shows a flowchart of the method of the invention. In step S1, the handheld computer 1 is connected to the personal computer 2 with the USB cable 3. An ADK (Accessory Development Kit) utility application is stored in the memory 311. In step S2, the ADK utility application in the memory is installed to the personal computer 2. In step S3, the handheld computer 1 is directed to a specific website. In step S4, a specific program is downloaded to the handheld computer 1. The specific program includes a personal computer version and a handheld computer version. In step S5, the handheld computer version of the specific program is installed into the handheld computer 1. Finally, in step S6, the personal computer version of the specific program is installed into the personal computer 2. After that, the handheld computer version and the personal computer version of the specific program are installed into the handheld computer 1 and the personal computer 2, respectively.

As a result, only the ADK utility application is stored in the memory. The capacity of the memory 311 can be substantially reduced than ever. This will substantially lower the manufacturing cost of the USB cable 3.

It will be appreciated by persons skilled in the art that the above embodiment has been described by way of example only and not in any limitative sense, and that various alterations and modifications are possible without departure from the scope of the invention as defined by the appended claims.

What is claimed is:

1. A method for installing an application into a handheld computer and a personal computer, comprising the steps of:
a) connecting the handheld computer to the personal computer with a USB (universal serial bus) cable with a memory in which an ADK (Accessory Development Kit) utility application is stored;
b) installing the ADK utility application to the personal computer;
c) directing the handheld computer to a specific website;
d) downloading a specific program including a personal computer version and a handheld computer version;
e) installing the handheld computer version of the specific program into the handheld computer; and
f) installing the personal computer version of the specific program into the personal computer.

2. The method of claim 1, wherein the handheld computer is a smartphone or a tablet computer.

3. The method of claim 1, wherein the personal computer is a desktop or a laptop computer.
